(19) United States
(12) Patent Application Publication
(10) Pub. No.: US 2005/0285936 A1
(43) Pub. Date: Dec. 29, 2005

(54) Three-dimensional display

(76) Inventors: Peter-Andre Redert, Eindhoven (NL); Marc Joseph Rita Op De Beeck, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/532,904

(22) PCT Filed: Oct. 8, 2003
(86) PCT No.: PCT/IB03/04437

§ 371 Date: Apr. 27, 2005

(30) Foreign Application Priority Data
Nov. 1, 2002 (EP) 02079580.3

(51) Int. Cl. H04N 5/14

(52) U.S. Cl. 348/25

(57) ABSTRACT

The invention provides a method for visualisation of a 3-dimensional (3-D) scene model of a 3-D image, with a 3-D display plane comprising 3-D pixels by emitting and/or transmitting light into certain directions by said 3-D pixels, thus visualising 3-D scene points. The calculation of the 3-D image is provided such that said 3-D scene model is converted into a plurality of 3-D scene points, said 3-D scene points are fed at least partially to at least one of said 3-D pixels, said at least one 3-D pixel calculates its contribution to the visualisation of a 3-D scene point.

The invention relates to a method for visualisation of a 3-dimensional (3-D) scene model of a 3-D image, with a 3-D display plane comprising 3-D pixels by emitting and/or transmitting light into certain directions by said 3-D pixels, thus visualising 3-D scene points.

The invention further relates to a 3-D display device comprising a 3-D display plane with 3-D pixels.

Three dimensional television (3-DTV) is a major goal in broadcast television systems. By providing 3-DTV, the user is provided with a visual impression that is as close as possible to the impression given by the original scene. There are three different methods for providing a 3-dimensional impression which are accommodation, which means that the eyelens adapts to the depth of the scene, stereo, which means that both eyes see a slightly different view on the scene, and motion parallax, which means that moving the head will give a new and possibly very different view on the scene.

One approach for providing a good impressing of a 3-D image is to record a scene by a high number of cameras. Each camera capturing the scene from a different viewpoint. For displaying the captured images, all of these images have to be displayed in viewing directions corresponding to the camera positions. During acquisition, transmission, and display occur many problems, as many cameras need much room and have to be placed very close to each other, the images from the cameras require high bandwidth to be transmitted, and also an enormous amount of signal processing for compression, decompression is needed and finally, many images have to be shown simultaneously.

From document WO 99/05559 a method for providing an N-view autostereoscopic display is disclosed, using a lenticular screen. By using the lenticular screen, each pixel may direct its light into a different direction, where the lightbeam of one lenticule is a parallel lightbeam. By providing this method, it is possible to display various views and thus providing a stereo impression for the viewer. The method disclosed therein needs the calculation of information about the direction of emission of light for each pixel outside each pixel.

Due to the deficiencies in the prior art method, it is an object of the invention to provide a method and a display device which allows bandwidth reduction between the display device and a control device. It is a further object of the invention to allow easy manufacturing of display devices. It is yet a further object of the invention to provide for a fully correct representation of the 3-D geometry of a 3-D scene.

These objects of the invention are solved by a method which is characterized in that said 3-D scene model is converted into a plurality of 3-D scene points, said 3-D scene points are fed at least partially to at least one of said 3-D pixels, and said at least one 3-D pixel calculates its contribution to the visualisation of a 3-D scene point. The calculation of the contribution of a 3-D pixel to a 3-D scene point within the 3-D pixel itself allows for high speed calculation of images. Also an enormous amount of images can be rendered without having to transmit these images from a separate unit to the display.

A 2-D pixel may be a device that can modulate the emission or transmission of light. A spatial light modulator may be a grid of NₓxN_{y} 2-D pixels. A 3-D pixel may be a device comprising a spatial light modulator that can direct light of different intensities in different directions. It may contain light sources, lenses, spatial light modulators and a control unit. A 3-D display plane may be a 2-D plane comprising an MₓxM_{y} grid of 3-D pixels. A 3-D display is the entire device for displaying images.

A voxel may be a small 3-D volume with the size Dₓ, D_{y}, D_{z}, located near the 3-D display plane. A 3-D voxel matrix may be a large volume with width and height equal to those of the 3-D display plane, and some depth. The 3-D voxel matrix may comprise Mₓ*M_{y}*M_{z} voxels. The 3-D display resolution may be understood as the size of a voxel. A 3-D scene may be understood as an original scene with objects.

A 3-D scene model may be understood as a digital representation in any format containing visual information about the 3-D scene. Such a model may contain information about a plurality of scene points. Some models may have surfaces as elements (VRML) which implicitly represent points. A cloud of points model may explicitly represent points. A 3-D scene point is one point within a 3-D scene model. A control unit may be a rendering processor that has a 3-D scene point as input and provides data for a spatial light modulator in 3-D pixels.

A 3-D scene always consists of a number of 3-D scene points, which may be retrieved from a 3-D model of a 3-D image. These 3-D scene points are positioned within a 3-D voxel matrix in and outside the display plane. Whenever a 3-D scene point is placed within the display plane, all 2-D pixels within one 3-D pixel co-operate, emitting light in all directions, defining the maximum viewing angle. By emitting light in all directions, the user sees this 3-D scene point within the display plane. Whenever a number of 2-D pixels from different 3-D pixels co-operate, they may visualise scene points positioned within a 3-D voxel matrix.

The human visual system observes the visual scene points at those spatial locations, where the bundle of light rays is “thinnest”. For each scene point, the internal structure of the light that is “emitted” depends on the depth of the scene point. Light that emerges in different directions from it, originates from different locations, different 2-D pixels, within the scene point, but this is perceptually not visible as long as the structure is below the eye resolution. That means that a minimum viewing distance should be kept from the display, similar to any conventional display. By emitting light within each 3-D pixel into a certain direction, all emitted light rays of all 3-D pixels interact, and their bundle of light rays is “thinnest” at different locations. The light rays interact at voxels within a 3-D voxel matrix. Each voxel may represent different 3-D scene points.

Each 3-D pixel may decipher whether or not to contribute to the 3-D 20 displaying of a particular 3-D scene point. This is a so called “rendering process” of one 3-D pixel. Rendering in the entire display is enabled by deciphering all 3-D scene points from one 3-D scene for or by all 3-D pixels.

A method according to claim 2 is preferred. 2-D pixels of one 3-D pixel contribute light to one 3-D scene point. Depending on the spatial position of a 3-D scene point, 2-D pixels from different 3-D pixels emit light so that the impression on a viewer's side is that the 3-D scene point is exactly at its spatial position as in the 3-D scene.

To provide a method which is resilient to errors within 3-D pixels, a method according to claim 3 is provided. By redistributing the 3-D scene points, errors in single 3-D pixels may be circumvented. The other 3-D pixels still provide light for the display of a 3-D scene point. Further, as missing 3-D pixels are similar to bad 3-D pixels, a square and a flat panel display can then be cut into an arbitrary shaped plane. Also, multiple display planes can be combined into one plane by only connecting their 3-D pixels. The resulting plane will still show the complete 3-D scene, only the shape of the plane will prohibit viewing the scene from some specific angles.

Parallel to redistributing the 3-D scene points within all 3-D pixels a distribution according to claim 4 is preferred. In this so called “load” mode, all images are actually acquired or rendered outside the 3-D pixels. After that they are loaded into the 3-D pixels. This may be interesting for displaying still images.

Rather than performing rendering in parallel within every 3-D pixel, a method according to claim 5 is proposed. A rendering process, e.g. the decision which 2-D pixel contributes light to displaying a 3-D scene point, can be done partly non-parallel by connecting several 3-D pixels to one rendering processor or to comprise a rendering processor within “master” pixels. An example is, to provide all rows of 3-D pixels of the display with one dedicated 3-D pixel comprising a rendering processor. In that case an outermost column of 3-D pixels may act as “master” pixel for that row, while the other pixels of that row may serve as “slave” pixels. The rendering is done in parallel by dedicated processors for all rows, but sequential within each row.

A method according to claim 6 is further preferred. All 3-D scene points within a 3-D model are offered to one or more 3-D pixels. Each 3-D pixel redistributes all 3-D scene points from its input to one or more neighbours. Effectively, all scene points are transmitted to all 3-D pixels. A 3-D scene point is a data-set, with information about position, luminance, colour, and further relevant data.

Each 3-D scene point has co-ordinates x, z, y and a luminance value I. The 3-D size of a 3-D scene point is determined by the 3-D resolution of the display which may be the size of the voxel of the 3-D voxel matrix. All of the 3-D scene points are sequentially, or in parallel, offered to substantially all 3-D pixels.

In general, each 3-D pixel has to know its relative position within the display plane grid to allow a correct calculation of the 2-D pixels contributing light to a certain 3-D scene point. However, a method according to claim 7 solves this problem. Each 3-D pixel may then change the co-ordinates of 3-D scene points slightly before transmitting them to its neighbours. This can be used to account for the relative difference in position between two 3-D pixels. In that case, no global position information needs to be stored within 3-D pixels, and the inner structure of all 3-D pixels can be the same over the entire display.

A so called “z-buffer” mechanism is provided according to claim 8. As a 3-D pixel receives a stream of all 3-D scene points, it may happen that more than one 3-D scene point needs the contribution of the same 2-D pixel. In case two 3-D scene points need for their visualisation the contribution of one 2-D pixel which is located within one 3-D pixel, it has to be decided which 3-D scene point “claims” this particular 2-D pixel. This decision is done by occlusion semantics, which means that the point that is closest to the viewer should be visible, as that point might occlude other scene points from his viewpoint.

As horizontal parallax is far more important than vertical parallax, a method according to claim 9 is provided. If horizontal parallax is incorporated, the number of 2-D pixels required for displaying a 3-D scene is reduced. A 3-D pixel with only one row of 2-D pixels might be sufficient for creating horizontal parallax.

To incorporate colour, a method according to claim 10 is provided. Within a 3-D pixel, more than one light source may be multiplexed spatially or temporally. It is also possible to have 3-D pixels for each basic colour, e.g. RGB. It should be noted that a triplet of three 3-D pixels may be incorporated as one 3-D pixel.

A further aspect of the invention is a display device, in particular for a pre-described method, where said 3-D pixels comprise an input port and an output port for receiving and putting out 3-D scene points of a 3-D scene, and said 3-D pixel at least partially comprise a control unit for calculating their contribution to the visualisation of a 3-D scene point representing said 3-D scene.

To enable transmission of 3-D scene points between 3-D pixels, a display device according to claim 12 is proposed.

A grid of 3-D pixels and a grid of 2-D pixels may also be provided. When the display is viewed at the correct minimum viewing distance, the grid of the 3-D pixels is below the eye resolution. Voxels will be observed with the same size. This size equals horizontally and vertically the size of the 3-D pixels. The size of a voxel in depth direction equals its horizontal size divided by tan (½α). Where a is the maximum viewing angle of each 3-D pixel, which also equals the total viewing angle of the display. For α=90°, the resolution is isotropic in all directions. The size of 3-D scene points grows linearly with depth, with a factor of 1+2|z|/N. This forms a restriction on how far scene points can be shown well in free space outside the display. At the depth position z=±½N scene points, the original resolution is divided in half in all directions, which can be taken as a maximum viewing bound.

A spatial light modulator according to claim 13 is preferred.

A display device according to claim 14 is also preferred, as by using a point light source, each 2-D pixel emits light into a very specific direction, all 2-D pixels of a 3-D pixel covering the maximum viewing angle.

During rendering, the display shows the previously rendered image. Only when an “end” signal is received, the entire display shows the newly rendered image. Therefore, buffering is needed as is provided by a display device according to claim 15. By using a so called “double buffering”, flickering during rendering may be avoided.

These and other aspects of the invention will be apparent from and elucidated with reference to the following figures. In the figures show:

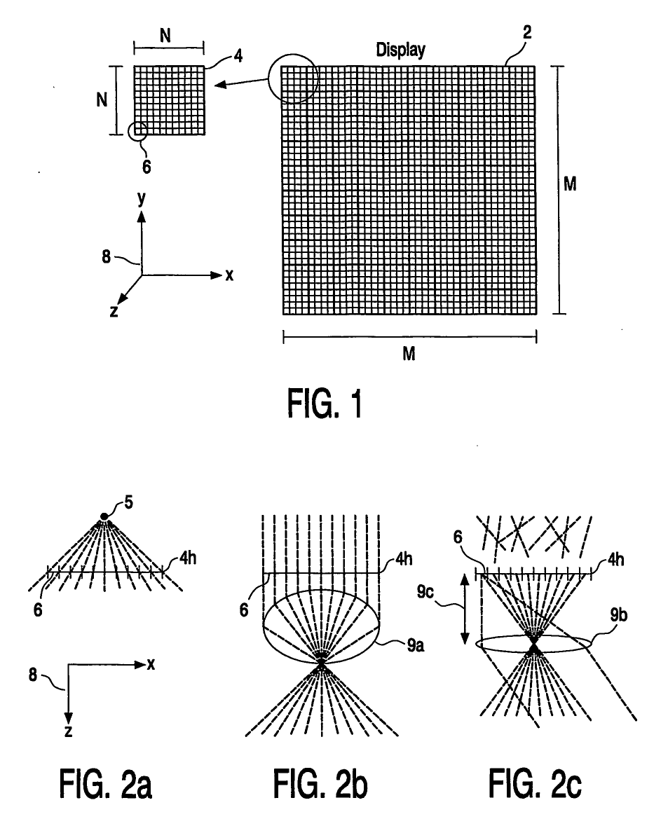

FIG. 1 a 3-D display screen;

FIG. 2 implementations for 3-D pixels;

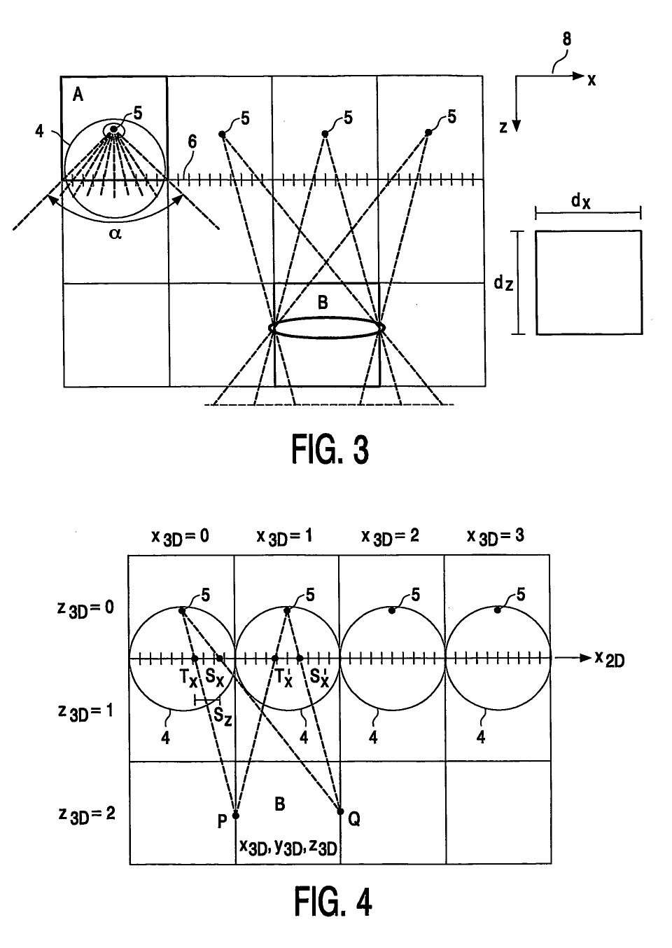

FIG. 3 displaying a 3-D scene point;

FIG. 4 rendering of a scene point by neighbouring 3-D pixels;

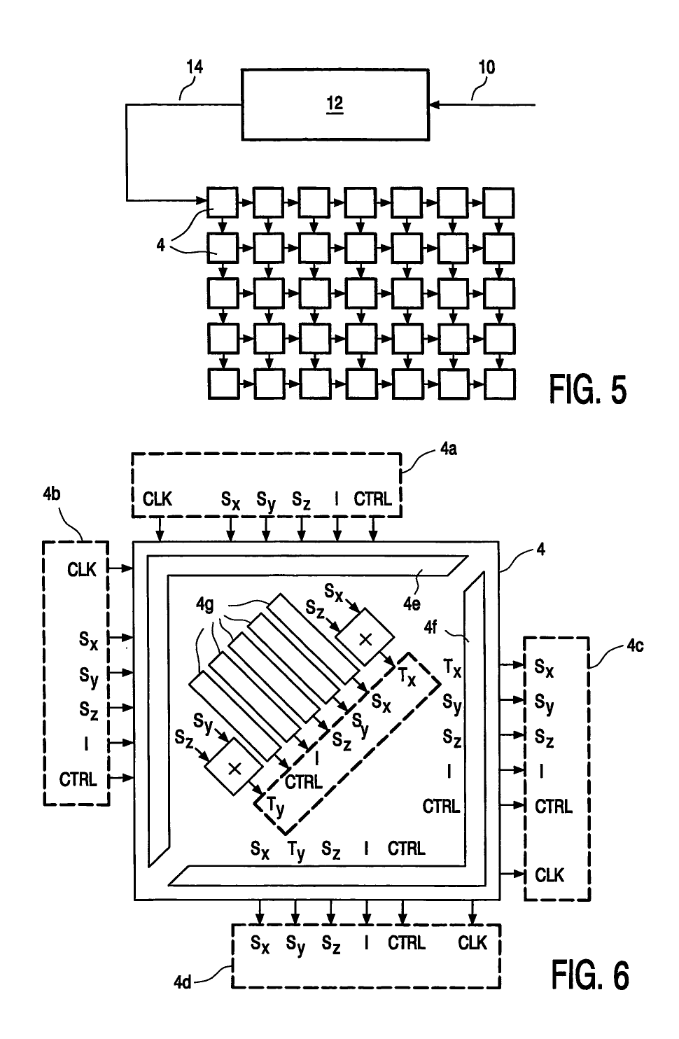

FIG. 5 interconnection between 3-D pixels;

FIG. 6 an implementation of a 3-D pixel;

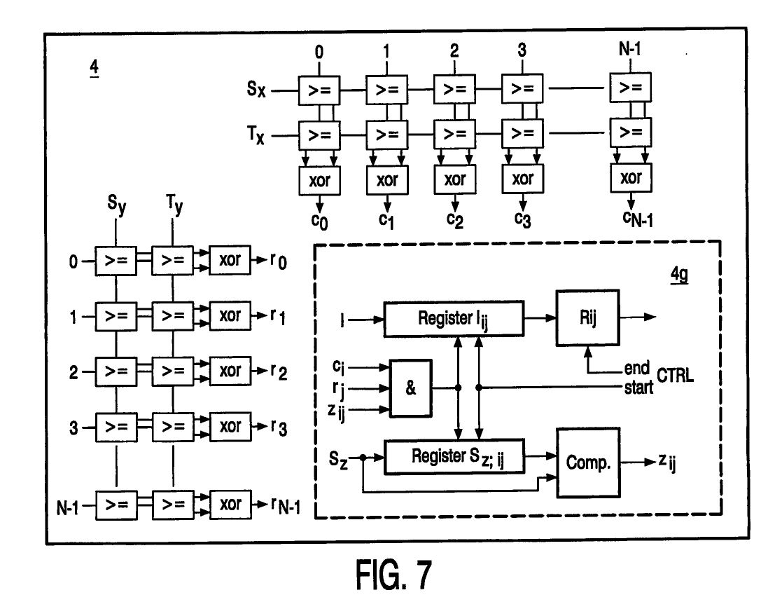

FIG. 7 an implementation for rendering within a 3-D pixel.

FIG. 1 depicts a 3-D display plane 2 comprising a grid of MₓxM_{y} 3-D pixels 4. Said 3-D pixels 4 comprise each a grid of NₓxN_{y} 2-D pixels 6. The display plane 2 depicted in FIG. 1 is oriented in the x-y plane as is also depicted by spatial orientation 8. Said 3-D pixels 4 provide rays of light by their 2-D pixels 6 in different directions, as is depicted in FIG. 2.

FIG. 2a-c show top-views of 2-D pixels 6. In FIG. 2a a point light source 5 is depicted, emitting light in all directions, in particular in direction of a spatial light modulator 4h. 2-D pixels 6 allow or prohibit transmission of ray of lights from said point light source 5 into various directions by using said spatial light modulator 4h. By defining, which 2-D pixel 6 allows transmission of light, the direction of light may be controlled. Said light source 5, said spatial light modulator 4h, and said 2-D pixels are comprised within a 3-D pixel 4.

FIG. 2b shows a collimated back-light for the entire display and a thick lens 9a This allows transmission of light in the whole viewing direction.

In FIG. 2c, a conventional diffuse back-light is shown. By directing the light through spatial light modulator 4h and placing a thin lens 9b in focus distance 9c from spatial light modulator 4h, light may be directed in certain directions from said thin lens 9b.

FIG. 3 depicts a topview of several 3-D pixels 4, each comprising 2-D pixels 6. In FIG. 3 the visualisation of a view of 3-D scene points within voxels A and B is depicted. Said 3-D scene points are visualised within voxels A and B within 3-D voxel matrix, each 3-D scene point may be defined by one voxel A, B of said 3-D voxel matrix. The resolution of a voxel is characterized by its horizontal size dₓ, its vertical size dy (not depicted) and its depth size d_{z}. Said point light sources 5 emit light onto the spatial light modulator, comprising a grid of 2-D pixels. This light may transmit or is blocked by said 2-D pixels 6.

The 3-D scene which the display shows, always consists of a number of 3-D scene points. Whenever the scene point is within the display plane, all 2-D pixels 6 within the same 3-D pixel co-operate, as depicted by voxel A, which means that light from said point light source 5 is directed in all directions, emerging from this 3-D pixel 4. The user sees the 3-D scene point within voxel A.

Whenever a number of 2-D pixels 6 from different 3-D pixels 4 co-operate, they may visualise scene points at positions within the 3-D voxel matrix of the display plane as can be seen with voxel B.

The ray of lights emitted from the various 3-D pixels 4 co-operate and their bundle of lights is “thinnest” at the position of a 3-D scene point represented by voxel B. By deciding which 2-D pixels 6 contribute light to which 3-D scene point, a 3-D scene may be displayed within the display range of the display 2. When the display is viewed at the correct distance, the 2-D voxel matrix resolution is below the eye resolution.

As can be seen in FIG. 4 in more detail, the rendering of one 3-D scene point within voxel B is achieved as follows. The rendering of one scene point with co-ordinates x_{3D}, y_{3D}, z_{3D} by the 3-D pixels 4 is depicted in FIG. 4. The figure is oriented in the x-z plane and shows a top-view of one row of 3-D pixels 4. The vertical direction is not shown, but all rendering processing in vertical direction is exactly the same as in horizontal direction.

To create a view of 3-D scene point within voxel B, two dedicated points P and Q within the voxel B are selected as indicated. From these points P, Q, lines are drawn towards the point light sources 5 within the 3-D pixels 4. For the 3-D pixel 4 on the left, this results in the intersections Sₓ and Tₓ. All 2-D pixels that have their middle in between these two intersections Sₓ and Tₓ should contribute to the visualisation of the 3-D scene point bounded by said points P and Q. The distance between the intersections Tₓ and Sₓ is the distance S_{z}.

Transformed co-ordinates with the values S_{z}, Sₓ, S_{y},Tₓ and T_{y} may be found for simplification of the implementation of the signal processing in the control units as

$${S}_{z} = \frac{1}{2} N \frac{- 1}{{z}_{3 D}}$$

$${S}_{x} = \frac{1}{2} N - {S}_{z} ( {x}_{3 D} + \frac{1}{2} )$$

$${S}_{y} = \frac{1}{2} N - {S}_{z} ( {y}_{3 D} + \frac{1}{2} )$$

$${T}_{x} = {S}_{x} + {S}_{z}$$

$${T}_{y} = {S}_{y} + {S}_{z}$$

The values Sₓ, S_{y} and S_{z} are transformed co-ordinates. Their value is in units of the x_{2D} and y_{2D} axes, and can be fractional (implementation by floating point or fixed point numbers). When Z_{3D} is zero, it can safely be set to a small non-zero value as e.g. Z_{3D}=±½, to avoid infinity in

$${S}_{z} = \frac{1}{2} N \frac{- 1}{{Z}_{3 D}}$$

this has no visible effect.

For the right-neighbouring 3-D pixel, the above identified values are transformed by every 3-D pixel prior to transmitting it to its neighbours, which means that a 3-D pixel needs no information about its own location within the display and are practically the same:
S_{z}′=S_{z}
Sₓ′=Tₓ
Tₓ′=Sₓ′+S_{z}′
t_{y}′=S_{y}′+S_{z}′.

A similar relation holds for neighbouring 3-D pixels in the vertical direction (not depicted in FIG. 4).

An error resilient implementation of 3-D pixels is depicted in FIG. 5. A 3-D scene model is transmitted to an input 10. This 3-D scene model serves as a basis for conversion into a cloud of 3-D scene points within block 12. This cloud of 3-D scene points is put out at output 14 and provided to 3-D pixels 4. From the first 3-D pixel 4, the cloud of 3-D scene points is transmitted to its neighbouring 3-D pixels and thus transmitted to all 3-D pixels within the display.

The implementation of a 3-D pixel 4 is depicted in FIG. 6. Each 3-D pixel 4 has input ports 4a and 4b. These input ports provide ports for a clock signal CLK, intersection signals Sₓ, S_{y} and S_{z}, luminance value I and a control signal CTRL. In block 4e it is selected which input from input ports 4a or 4b is provided for said 3-D pixel 4 which is made on basis of a clock signal CLK present. In case both clock signals CLK are present, an arbitrary selection is made. The input co-ordinates Sₓ, S_{y} and S_{z} and luminance value I of scene points and some control signals CTRL are used for calculation of the contribution of the 3-D pixel for the display of a 3-D scene point. After selection of an input port, all signals are buffered in registers 4g. This makes the system a pipelined system, as data travels from every 3-D pixel to the next 3-D pixel at every clock cycle.

Within the 3-D pixel 4, two additions are performed to obtain Tₓ and T_{y}, after which the transformed data set is sent to horizontal and vertical neighbouring 3-D pixels 4. The output is checked by block 4f. If the 3-D pixel 4 decides that it is not functioning correctly itself, via a self-check, it does not send its clock signal CLK to its neighbours, so that those 3-D pixels 4 will receive only data from other, correctly functioning neighbouring 3-D pixels 4. The additions performed in 3-D pixel 4 are Sₓ+S_{z} as well as S_{y}+S_{z}.

The rendering process is carried out within a 3-D pixel 4. To control the rendering process, global signals “start” and “end” are sent to all 3-D pixels within the entire display. Upon the reception of a “start” signal, all 3-D pixels are reset and all 3-D scene points to be rendered are sent to the display. As all 3-D scene points have to be provided to all 3-D pixels, some clock cycles have to be waited to ensure that the last 3-D scene point has been received by all 3-D pixels in the display. After that, the “end” signal is sent to all 3-D pixels of the display.

During the rendering period the display shows the previously rendered image. Only after reception of the “end” signal, the entire display shows the newly rendered image. This is a technique called “double buffering”. It avoids that viewers observe flickering. This might otherwise occur, as during rendering the luminance of 2-D pixels may change several times, e.g. due to “z-buffering”, since a new 3-D scene point may occlude a previous 3-D scene point.

The rendering within a 3-D pixel 4 is depicted in FIG. 7. For each 2-D pixel within a 3-D pixel a calculation device 4g is comprised, which allows for the computation of a luminance value I and transformed depth S_{z}. The calculation device 4g comprises three registers Iᵢⱼ, S_{z,ij} and Rᵢⱼ. The register Iᵢⱼ is a temporary luminance register, the register S_{zij} is a temporary transformed depth register and the register Rᵢⱼ is coupled directly to the spatial light modulator so that a change of its value changes the appearance of the display. For each 2-D pixel, a value rᵢ and cⱼ is computed. The variable r, represents a 2-D pixel value in vertical direction and the variable cⱼ represents a 2-D pixel value in horizontal direction. These variables rᵢ and cⱼ denote whether the particular 2-D pixel lies in between intersections S and T vertically and horizontally, respectively. This is done by comparators and XOR-blocks, as depicted in FIG. 7 on the left and top.

The comparators in horizontal direction decide, whether the co-ordinates Sₓ and Tₓ lie within a 2-D pixel 0 to N-1 in horizontal direction. The comparators in vertical direction decide, whether the co-ordinates S_{y} and T_{y} lie within a 2-D pixel 0 to N-1 in vertical direction. If the co-ordinates lie between two 2-D pixels, the output of one of the comparators is HIGH and the output of the XOR box is also HIGH.

Within one 3-D pixel, Nₓ*N_{y} 2-D pixels are provided, with indexes 0<=ij<=N-1. Each 2-D pixel ij has registers, one for luminance Iᵢⱼ, one for transformed depth S_{z,ij} of the voxel to which this 2-D pixel is contributed at a particular moment during rendering, and one Rᵢⱼ coupled to the spatial light modulator of the 2-D pixel (not depicted). The luminance value for each pixel is determined by the variables rᵢ and cⱼ and the depth variable zᵢⱼ, which denotes the depth of the contributed voxel. The zᵢⱼ value is a boolean variable from the comparator COMP, that compares the current transformed depth S_{z} with the transformed depth S_{z,ji}.

Whether the contribution of a 2-D pixel to a past 3-D scene point should change to the 3-D scene point currently provided at the input depends on three necessary requirements:

a) the intersection requirement is met horizontally (cᵢ=1);

b) the intersection requirement is met vertically (rⱼ=1);

c) the current 3-D scene point lies closer to the viewer than the past 3-D scene point (zᵢⱼ=1).

The control signal “start” resets all registers. The register Iᵢⱼ is set to “black” and S_{zij} to a value representing z=minus infinity. After that, all 3-D scene points are provided to all 3-D pixels. For each 3-D scene point, the luminance values for all 2-D pixels are determined. In case, a 2-D pixel lies between intersection S and T, which means rᵢ=cⱼ=1, a “z-buffer” mechanism decides whether the new 3-D scene point lies closer to the viewer than a previously rendered one. When this is the case, the 3-D pixel decides that the 2-D pixel should contribute to the visualisation of the current 3-D scene point. The 3-D pixel then copies the 3-D scene point luminance information into its register Iᵢⱼ and the 3-D scene point depth information into register S_{zij}.

When the “end” signal is received, the luminance register Iᵢⱼ value is copied to the register Rᵢⱼ for determining the luminance of each 2-D pixel for displaying the 3-D image.

By providing the described method, any number of viewers can simultaneously view the display, no eye-wear is needed, stereo and motion parallax is provided for all viewers and the scene is displayed in fully correct 3-D geometry.

1. Method for visualisation of a 3-dimensional (3-D) scene model of a 3-D image, with a 3-D display plane comprising 3-D pixels by
emitting and/or transmitting light into certain directions by said 3-D pixels, thus visualising 3-D scene points, characterized in that
said 3-D scene model is converted into a plurality of 3-D scene points,
said 3-D scene points are fed at least partially to at least one of said 3-D pixels,
said at least one 3-D pixel calculates its contribution to the visualisation of a 3-D scene point.

2. Method according to claim 1, characterized in that light is emitted and/or transmitted by 2-D pixels comprised within said 3-D pixels, each 2-D pixel directing light into a different direction contributing light to a scene point of said 3-D scene model.

3. Method according to claim 1, characterized in that said 3-D scene points are provided sequentially, or in parallel, to said 3-D pixels.

4. Method according to claim 1, characterized in that the contribution of light of a 3-D pixel to a certain 3-D scene point is made previous to the provision of said 3-D scene points to said 3-D pixels.

5. Method according to claim 1, characterized in that the contribution of light of a 3-D pixel to a certain 3-D scene point is calculated within one 3-D pixel of one row or of one column previous to the provision of said 3-D scene points to the remaining 3-D pixels of a row or a column, respectively.

6. Method according to claim 1, characterized in that a 3-D pixel outputs an input 3-D scene point to at least one neighbouring 3-D pixel.

7. Method according to claim 1, characterized in that each 3-D pixel alters the co-ordinates of a 3-D scene point prior to putting out said 3-D scene point to at least one neighbouring 3-D pixel.

8. Method according to claim 1, characterized in that in case more than one 3-D scene point needs the contribution of light from one 3-D pixel, the depth information of said 3-D scene point is decisive.

9. Method according to claim 1, characterized in that said 2-D pixels of a 3-D display plane transmit and/or emit light only within one plane.

10. Method according to claim 1, characterized in that colour is incorporated by spatial or temporal multiplexing within each 3-D pixel.

11. 3-D display device, in particular for a method according to claim 1, comprising:
a 3-D display plane with 3-D pixels,
said 3-D pixels comprise an input port and an output port for receiving and putting out 3-D scene points of a 3-D scene,
said 3-D pixel at least partially comprise a control unit for calculating their contribution to the visualisation of a 3-D scene point representing said 3-D scene.

12. 3-D display device according to claim 11, characterized in that said 3-D pixels are interconnected for parallel and serial transmission of 3-D scene points.

13. 3-D display device according to claim 11, characterized in that said 3-D pixels comprise a spatial light modulator with a matrix of 2-D pixels.

14. 3-D display device according to claim 11, characterized in that said 3-D pixels comprise a point light source, providing said 2-D pixel with light.

15. 3-D display device according to claim 11, characterized in that said 3-D pixels comprise registers for storing a value determining which ones of said 2-D pixels within said 3-D pixel contribute light to a 3-D scene point.
